(19) United States
(12) Patent Application Publication
(10) Pub. No.: US 2005/0054502 A1
(43) Pub. Date: Mar. 10, 2005

(54) Automated manufacturing line for boxgoods

(76) Inventor: Ted Benyovits, Weston (CA)

Correspondence Address: DENNISON ASSOCIATES, SUITE 301, 133 RICHMOND STREET WEST, TORONTO, ON, M5H 2L7, CA

(21) Appl. No.: 10/655,618

(22) Filed: Sep. 5, 2003

(51) Int. Cl. B31B 1/26

(52) U.S. Cl. 493/69

(57) ABSTRACT

The present invention is directed to an automated manufacturing line for production of boxlike structures and components therefor from laminated or solid flat material by V grooving, folding and gluing to form the boxlike structure or component. The automated line includes two or more machines selected from lineal V groovers, continuous cross V groovers, edge folding and gluing machines and multiple scoring machines. Each of the machines is provided with fences and feeders for automatically guiding the workpiece through the automated line. The positioning of fences, feeders, cutting heads and applicators of each of the machines is fully adjustable by providing drive means to position the fence, feeder, cutting head and applicator according to a predetermined position required for the production of a particular boxlike structure or component. The drive means is controled by a programmed controller having the parameters of the boxlike structure or component and having a means to cause the drive means to be activated to position the fence, feeder, cutting head or applicator in the correct position for the production of the desired boxlike structure or component.

### FIELD OF THE INVENTION

The present invention relates to an automated manufacturing line for production of boxlike structures and components therefor from laminated or solid flat material by V grooving, folding and gluing to form the boxlike structure or component. In particular, the present invention relates to an automated manufacturing line that is simple and fast to change from one setup to another.

### BACKGROUND OF THE INVENTION

The production of casegoods based upon boxlike structures is commonly employed for furniture and other items such as speaker enclosures and similar structures. Such products are commonly manufactured from laminated or solid flat material such as particleboard, Fiberboard, MDF or other flat solid material to which a veneer or laminate of wood, vinyl, textile, high-pressure laminate and other covering material has been applied or solid flat material such as solid wood or solid surface material. In order to provide a finished edge to the product the edge may also be veneered or the material may be V grooved to provide for an edge which is folded over to provide a finished appearance to the edge of the material. Such V grooving and folding operations are commonly accomplished by a lineal V grooving machine cutting through the backside of the laminated or solid material and then folding and gluing the material utilizing a folding and gluing machine. To form the box shape cross V grooves are cut and the material is folded and glued to form the box.

While the manufacturing methods described above results in the production of cabinets and other boxlike products at relatively low cost with strong joints, should it be necessary to change the machine to provide for boxlike products of different dimensions, the setup and changeover of the machines can be very labor-intensive and can take several hours. This has generally required that the manufacturer produce a large number of the same product that will be stored in inventory before the machine is converted over to produce the next product. Recently, the concept of just in time or made to order manufacturing has become popular and necessary. In these situations, the manufacturer produces the required products as they are ordered and does not maintain an extensive inventory. If it takes too long for the machines to be changed from the set up for producing one product to the set up required to produce another product, it will not be possible to achieve made to order manufacturing.

There thus remains a need for a rapid method of setup and changeover of machines and particularly a plurality of machines utilized in an automatic lineal V grooving line.

### SUMMARY OF THE INVENTION

The present invention is directed to an automated manufacturing line for production of boxlike structures and components therefor from laminated or solid flat material by V grooving, folding and gluing to form the boxlike structure or component. The automated line includes two or more machines selected from lineal V groovers, continuous cross V groovers, edge folding and gluing machines and multiple scoring machines. Each of the machines is provided with fences and feeders for automatically guiding the workpiece through the automated line. The positioning of fences, feeders, cutting heads and applicators of each of the machines is fully adjustable by providing drive means to position the fence, feeder, cutting head and applicator according to a predetermined position required for the production of a particular boxlike structure or component. The drive means is controlled by a programmed controller having the parameters of the boxlike structure or component and having a means to cause the drive means to be activated to position the fence, feeder, cutting head or applicator in the correct position for the production of the desired boxlike structure or component.

In an aspect of the invention, the drive means are encoded servomotors to provide a feedback to the controller as to its position and thereby the position of the fence, feeder, cutting head or applicator to which the servomotor is attached.

### BRIEF DESCRIPTION OF THE DRAWINGS

Preferred embodiments of the automatic the V grooving machines and methods of the present invention are illustrated in the attached drawings in which:

FIG. 1 is a schematic view of the automated line of the present invention;

FIG. 2 is a top side and end view of the lineal V grooving machine of the automated line of FIG. 1;

FIG. 3 is a top, side and end view of the folding and gluing machine of the automated line of FIG. 1;

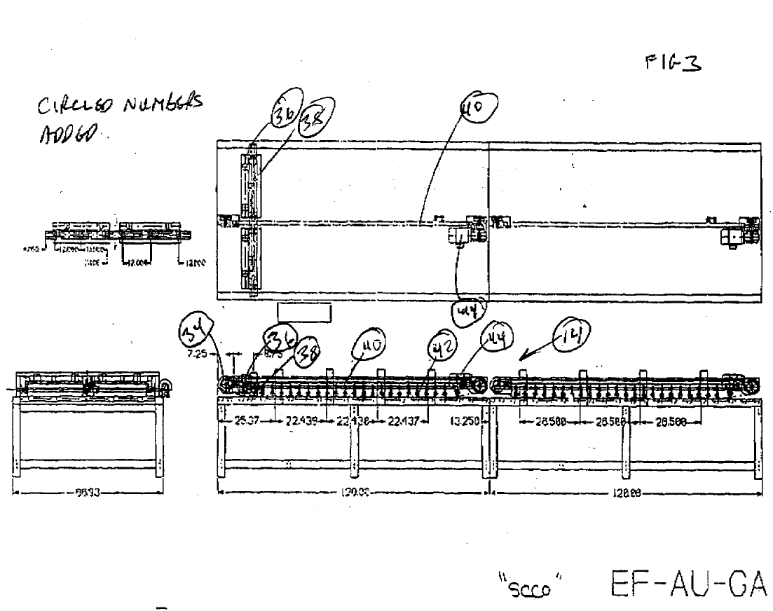

FIG. 4 is a top side and end view of the Cross V grooving machine of the automated line of FIG. 1;

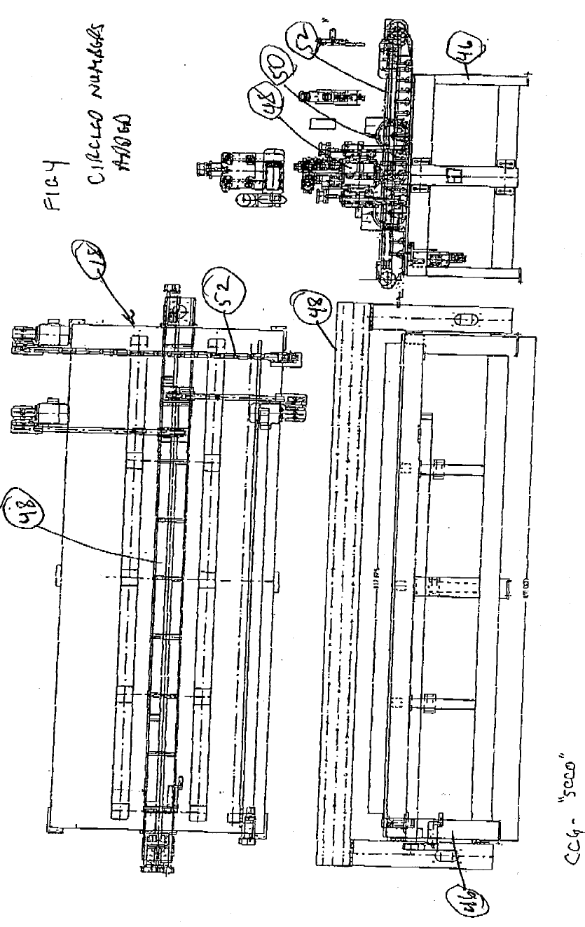

FIG. 5 is a perspective view of a preferred embodiment of the servomotor positioning control;

FIG. 6 is a flowchart of a first control program of the automated line of FIG. 1; and

FIG. 7 is a flowchart of a second control program of the automated line of FIG. 1.

### DETAILED DESCRIPTION OF THE PREFERRED EMBODIMENTS

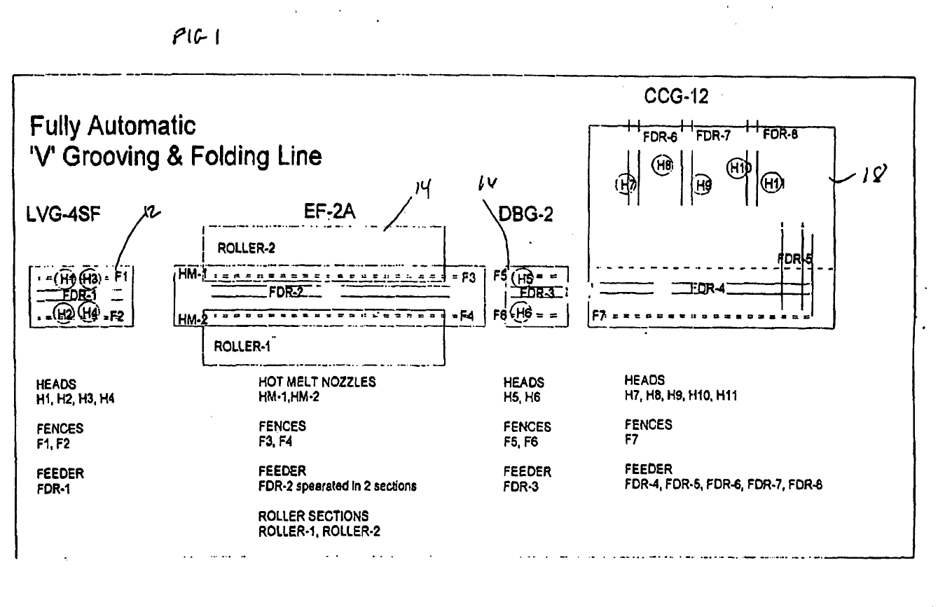

A preferred embodiment of an automated V grooving line according to the present invention is illustrated in schematic view in FIG. 1. The preferred automatic V grooving line includes a linear V grooving machine 12, an edge folder and gluing machine 14, a multiple scoring machine 16, and a continuous Cross V grooving machine 18. Each of these machines is provided with fences and feeders for automatically guiding the work pieces through the automated line as will the described further below.

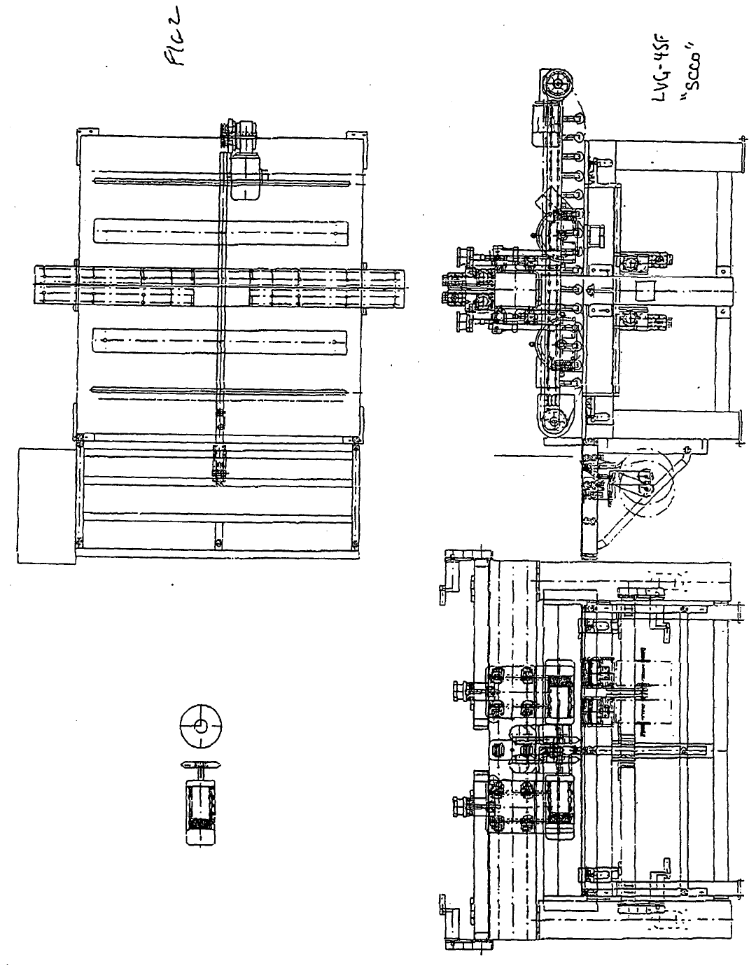

The details of the lineal V grooving machine 12 is illustrated in FIG. 2. The lineal V grooving machine is provided with a welded frame structure that prevents excess vibrations even with large capacity motors. The use of a variable speed drive permits synchronization of the lineal V grooving machine with the other machines in the automated line. The lineal V grooving machine is provided with a plurality of cutting heads mounted on a Cross beam for proper positioning for the desired grooves in the work pieces as will be described below. The work pieces are supported by scratch resistant high-pressure laminated surfaces, which are on the same level through the full length of the machine. Directly below the position of the cutting heads a solid Formica or similar material insert to properly support the work pieces as it passes below the cutting heads. The work pieces are fed through the lineal V grooving machine by means of overhead feed belts. In the embodiment illustrated in FIG. 2 two such belts are provided. The lateral positioning of the feed belts is adjustable to adapt the machine to different sizes of work pieces as will be described further below. The belts ride on spring loaded idler wheels that allow the belt drive to easily adapt to different thickness of work pieces. The use of the material support system as described above prevents scratches to the vinyl or laminate surface that is supported on the table. The feed belts, which feed the work pieces through the machine, ride against the unlaminated side of the work pieces that will be to the interior of the finished article.

The V grooving machine 10 may also be provided with a tape dispenser 20, which dispenses tape 22 onto the underside of the work piece along the anticipated cut lines. The use of the tape holds the pieces of rigid laminated or solid material work pieces together after they have been V grooved and acts as a hinge to allow for ease of folding and gluing of the work piece. If the laminate used in the material is flexible, e.g. textiles and vinyl, then the tape may not be necessary, as the laminate itself will be able to act as the hinge for bending of the material.

Once the work pieces has been lineal V grooved, the V grooved edge of the board is glued and folded. To accomplish this an automated edge folder and gluing machine is utilized. The automated edge folder is provided at the in feed with a rotary brush and air jet that cleans the grooves of any sawdust that may remain from the V grooving operation. The sawdust is removed by the suitable exhaust system. Next the proper adhesives are applied to the grooves. Preferably two adhesives are utilized; a polyvinyl acetate (PVA) adhesive and a hot melt adhesive. The PVA adhesive provides the strength of the fold, and the hot melt adhesive holds the fold in position while the PVA adhesive sets. The PVA adhesive is firstly applied to the groove in a bead or spray through a nozzle, after which the hot melt adhesive is applied by an automatic gun. After the adhesive is applied, the work pieces enters a folding and compression section were a large number of fully adjustable rollers perform these operations. For effective folding of cold or brittle laminates, an optional thermostatically controlled strip heater may be provided.

The work pieces are fed through the edge folder and gluing machine by means of a belt drive having spring loaded idler wheels to adjust to the different thickness of material. The belt drive is driven by a variable speed motor to allow it to be synchronized with the other machines of the automated line. Once the work piece with the folded edge leaves the machine the holding strength of the hot glue is sufficient that the work piece may be subjected to further operations immediately.

After the folding and gluing operation, the work piece may be fed through a multiple scoring machine that will cut any necessary dados for inserts for the finished product. The cutting heads, fences and belt drive of the multiple scoring machine are controlled in a similar manner as the other machines of the automated line.

The finished glued and folded work pieces are then cross V grooved before being folded into the desired box shape. The Cross V grooving demands the greatest accuracy from the V grooving equipment since the tolerance of the grooves are multiplied when the work piece is folded together into box. The continuous cross V grooving machine of the automated line of the present invention provides for such accuracy. The machine is provided with a welded frame structure with heavy section overhead beams to provide proper mountings for the precision cutting heads. The heads are laterally adjustable along the beams as well as being adjustable up-and-down to adapt to various cutter sizes and different vinyl or film thickness. The glued and folded work pieces are fed along the machine to position against the stops. A positioning sensor moves the work piece until the continuous cross V grooving machine feeders take the work piece through the cutting process. A separate feeder then moves the work pieces past the cutting heads that cut the proper V grooves in the surface of the work pieces. Typically the Cross V grooving machine will be equipped with at least five cutting heads three of which will be provided with cutters to cut 90 degree V grooves and the outside two heads equipped with cut off saws tilted at a 45 degree angle. The cross V grooving machine may also be provided with a tape dispenser that dispenses tape onto the underside of the work piece along the anticipated cut line. The use of the tape holds the pieces of rigid laminated or solid material work pieces together after they have been V grooved and acts as a hinge to allow for ease of folding and gluing of the work piece. If the laminate used in the material is flexible, e.g. textiles and vinyl, then the tape may not be necessary, as the laminate itself will be able to act as the hinge for bending of the material. Once the proper cuts are made in the work pieces, the work pieces are fed off of the machine and then may be folded and glued to form a final desired shape.

In order to provide for fully automated operations and especially automated changeover of the machines, each of the components of the machines which process the work pieces are fully and automatically adjustable and in particular easily adjusted. Thus each of the cutter heads, feeders and fences of the linear V grooving machine as well as the adhesive applicators, fences, feeders and roller sections of the edge folding and gluing machine the heads, fences and feeders of the multiple scoring machine and the heads, fences and feeders of the Cross V grooving machine are easily adjustable. This adjustment is preferably provided by utilizing servomotors to properly position the various components of the automated line such as the cutting heads, fences, feeders, adhesive applicators, and rollers. The servomotors employed are encoded so that at anytime the servomotor may provide a feedback to the control system as to its position and thus the position of the components which it is utilized to position. The use of the servomotors along with the control system such as will be described below allows for complete control of both individual machines as well as the overall line. This allows the machines and entire line to be changed over from one configuration of final product to another in minutes instead of the hours which was required in the machines of the prior art.

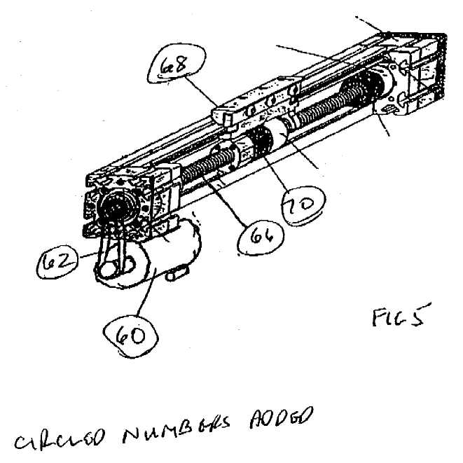

A preferred embodiment of the servomotor positioning apparatus is illustrated in FIG. 5. The Servomotor drive is connected to a one side of a belt drive or gear drive to which a suitable positioning apparatus for the adjustable component is attached. In the embodiment illustrated, the positioning apparatus is a ball screw unit having a threaded spindle with one end of the spindle attached to the second side of the belt or gear drive. A yoke adapter for mounting of the adjustable component such as the cutting head or fence is movable along the length of the ball screw unit. The yoke adapter is connected to a drive nut that moves along the threaded spindle as the spindle is rotated which in turn moves the yoke adapter and attached adjustable component. The servomotor and ball screw unit is setup by setting the origin position and the limit of travel of the ball screw unit and the position of the motor determined at each limit. Once this is set, then the position of the motor will directly relate to the position of the adjustable component attached to the ball screw unit. While the positioning apparatus has been described as using servomotors and ball screws, other means of positioning of the adjustable components can be used, as will be apparent to those skilled in the art. For example, stepper motors may be employed in place of the servomotor and a rack and pinion arrangement may be employed in place of the ball screw.

The control system of the automated line of the present invention preferrably utilizes a CPU that contains the instruction programs for the setup of the machines of the automated line as well as the dimensions of the work pieces to be processed by the line. The CPU is connected to a display module such as a video display terminal that is utilized during programming and operation of the machine. A suitable input device such as a keyboard and/or mouse is also connected to the CPU for input the parameters of the programming and data. Alternatively the video display terminal may be provided with a touch screen through which the user can interface with the CPU by touching areas on the screen, which correspond to demands for the CPU. The CPU is connected to a servomotor controller through a suitable I/O interface to both provide instructions to the servomotor to properly position the component controlled by the motor as well as to query the servomotor as to its current position.

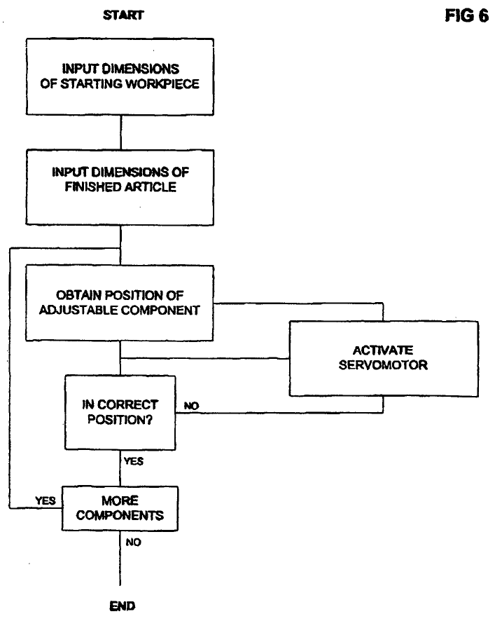

A first control program of the automated line of the present invention is illustrated in a flowchart in FIG. 6. This control program requires that the operator input the dimensions of the finished article and the dimensions of the starting work piece into the data storage. Firstly the user will input the width, length and thickness of the starting work piece which dimensions will be analyzed to adjust the positions of the feeders and fences of the various machines of the line. The thickness of the laminate provided on the surface of the work piece is then input which will be utilized to adjust the height of the cutting heads of the linear V grooving machine and the Cross V grooving machines. Next the dimensions of the desired finished edges of the article are input which will be utilized in the proper lateral positioning of the cutting heads of the linear V grooving machine. The finished dimensions of the article in terms of height and depth are then input which dimensions are utilized for the setup of the cutting heads of the linear V grooving machine, the adhesive applicators and folding and compression sections of the edge folder and gluing machine as well as the positioning of the cutting heads of the multiple scoring machine and the Cross V grooving machine. Once all of these dimensions have been input into the system, the CPU utilizes its programming to properly adjust all the components of the automated line by operating the servomotors until it has received feedback from the motors that the components are properly positioned. This would typically take a matter of minutes. Once the automated line is set up, the operator may then commence feeding the work pieces onto the table of the first machine after which the work piece progresses along the automated line until the completed work piece is taken off the line at the last machine and then cleaned, glued with cold PVA and hot melt adhesives and finally clamped to produce the final product.

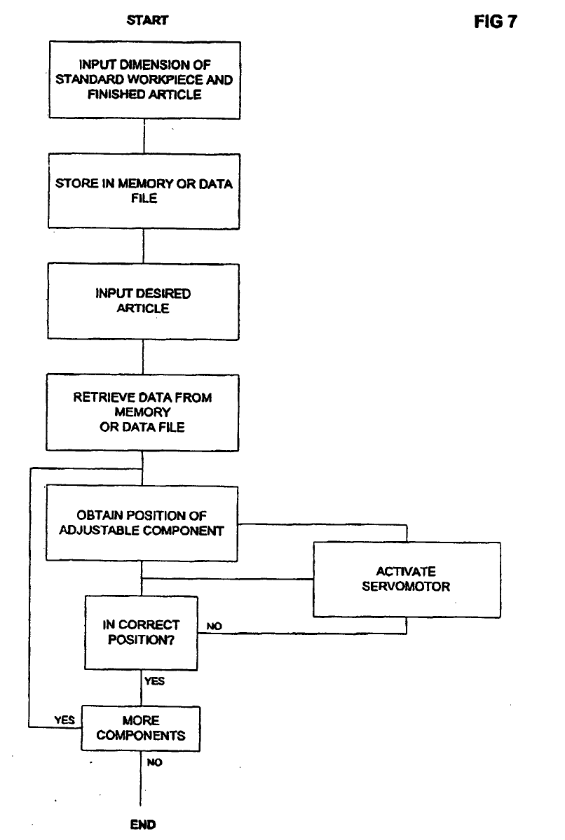

A second control program according to the present invention is illustrated in a flowchart in FIG. 7. In this control method, the dimensions and setting for a particular desired product are preprogrammed in the control unit. When it is desired to produce a particular product, the user merely selects the product from a list or touches a graphic on a touch screen that shows the product. Once the product is selected, the control unit retrieves the dimensions and settings from the preprogrammed memory and the adjustable components of the automated line are properly positioned by operating the servomotors until the control unit has received feedback from the motors that the components are properly positioned. The operator may then commence feeding the work pieces onto the table of the first machine after which the work piece progresses along the automated line until the completed work piece is taken off the line at the last machine and then cleaned, glued with cold PVA and hot melt adhesives and finally clamped to produce the final product.

The automated V grooving line of the present invention allows for simple and rapid set up of the machines in the line. This is true both for initial set up of the machines as well as when the line is being changed over from the production of one product to another. As the changeover is so easy, a manufacturing facility can produce a wider variety of products made to order economically without having to invest in significant amounts of finished inventory to cover the orders as they are received. The results in increased production at lower costs.

While the preferred embodiment has been described as having all four of the above machines, it will be appreciated that it is not necessary for all of the machines to be present to achieve the advantages of the present invnetion. In some circumstances, the maunufacturer may wish to produce components of the finished product. In these situations, only a lineal V grooving machine and edge folder and gluing machine may be required. For some components, a multiple scoring machine may be added while for other components, only a continuous cross V grooving machine may be added to the lineal V grooving machine and edge folding and gluing machine. In all of these setups, the control of the setup of the individual machines as well as the whole line is accomplished as described above.

Although various preferred embodiments of the present invention have been described herein in detail, it will be appreciated by those skilled in the art, that variations may be made thereto without departing from the spirit of the invention or the scope of the appended claims.

1. An automated manufacturing line for production of boxlike structures and components therefor from flat laminated material having a wood base core or solid flat wood or solid surface material by V grooving, folding and gluing to form the boxlike structure or component, the automated line comprising two or more machines selected from lineal V groovers, continuous cross V groovers, edge folding and gluing machines and multiple scoring machines, each of the machines being provided with fences and feeders for automatically guiding a workpiece through the automated line, the positioning of each of the fences, feeders, cutting heads and applicators of each of the machines being automatically adjustable by providing drive means attached to each of the fence, feeder, cutting head and applicator to position each of the fence, feeder, cutting head of and applicator according to a predetermined position required for the production of a particular boxlike structure or component, the drive means being controled by a programmable controller having the parameters of the boxlike structure or component programmed therein and having a means to cause the drive means to be activated to position the fence, feeder, cutting head or applicator in the correct position for the production of the desired boxlike structure or component.

2. An automated line according to claim 1 wherein the drive means are encoded servomotors to provide a feedback to the controller as to its position and thereby the position of the fence, feeder, cutting head or applicator to which the servomotor is attached.
